(19) United States
(12) Patent Application Publication
(10) Pub. No.: US 2026/0003822 A1
(43) Pub. Date: Jan. 1, 2026

(54) SPACE EFFICIENT ARCHIVAL OF TABLES

(71) Applicant: Snowflake Inc., Bozeman, MT (US)

(72) Inventors: Robert Bengt Benedikt Gernhardt, Seattle, WA (US); Tianlun LI, Snohomish, WA (US); Xinglian Liu, Redmond, WA (US); Nithin Mahesh, Kirkland, WA (US)

(21) Appl. No.: 18/758,273

(22) Filed: Jun. 28, 2024

(51) Int. Cl. G06F 16/11

(52) U.S. Cl. CPC G06F 16/113; G06F 16/128

(57) ABSTRACT

Cloning operations can be used generate snapshots of tables at specified times. The snapshot objects can be stored in a first-tier storage with the table, where the cloned versions of the tables and the table may share files, such as micro-partition files, to conserve storage resources. After a first expiration time, snapshot objects can be transferred from the first-tier storage to a second-tier storage to further save on storage costs. After a second expiration time (e.g., full retention period), the snapshot objects can be deleted from the second-tier storage as well.

### TECHNICAL FIELD

The present disclosure generally relates to data systems, and, more specifically, to database archival techniques.

### BACKGROUND

Data systems, such as database systems, may be provided through a cloud platform, which allows organizations and users to store, manage, and retrieve data from the cloud platform. Database sizes are increasing where database tables may include thousands or millions of rows of data.

Some users may wish to regularly archive database data, such as for regulatory purposes. Some conventional techniques typically save copies of full databases each time for archival purposes, leading to increased storage costs especially for databases with large amounts of data.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a schematic diagram of a data structure for storage of database metadata, according to some example embodiments.

FIG. 5 is a schematic diagram of a data structure for storage of database metadata, according to some example embodiments.

FIG. 6 shows an example of using a snapshot to archive database data, according to some example embodiments.

FIG. 7 shows a network flow of storing snapshots in different tiered storage locations, according to some example embodiments.

FIGS. 8A-8C shows an example of using an aggregate list of expression properties (EP) files, according to some example embodiments.

FIG. 9 shows a flow diagram of a method for archiving a snapshot in a second-tier storage, according to some example embodiment.

FIG. 10 shows a flow diagram of a method for restoring a table for a snapshot stored in a second-tier storage, according to some example embodiment.

FIG. 11 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described herein are techniques for archiving different versions of database objects, such as tables. For example, some industries may require that companies archive data regularly (e.g., every hour, day, etc.) and store the archive copies for a prolonged retention period. The techniques described herein may use cloning operations to generate snapshots of tables at specified times. The snapshot objects can be stored in a first-tier storage with the table, where the cloned versions of the tables and the table may share files, such as micro-partition files, to conserve storage resources. After a first expiration time, snapshot objects can be transferred from the first-tier storage to a second-tier storage to further save on storage costs. After a second expiration time (e.g., full retention period), the snapshot objects can be deleted from the second-tier storage as well.

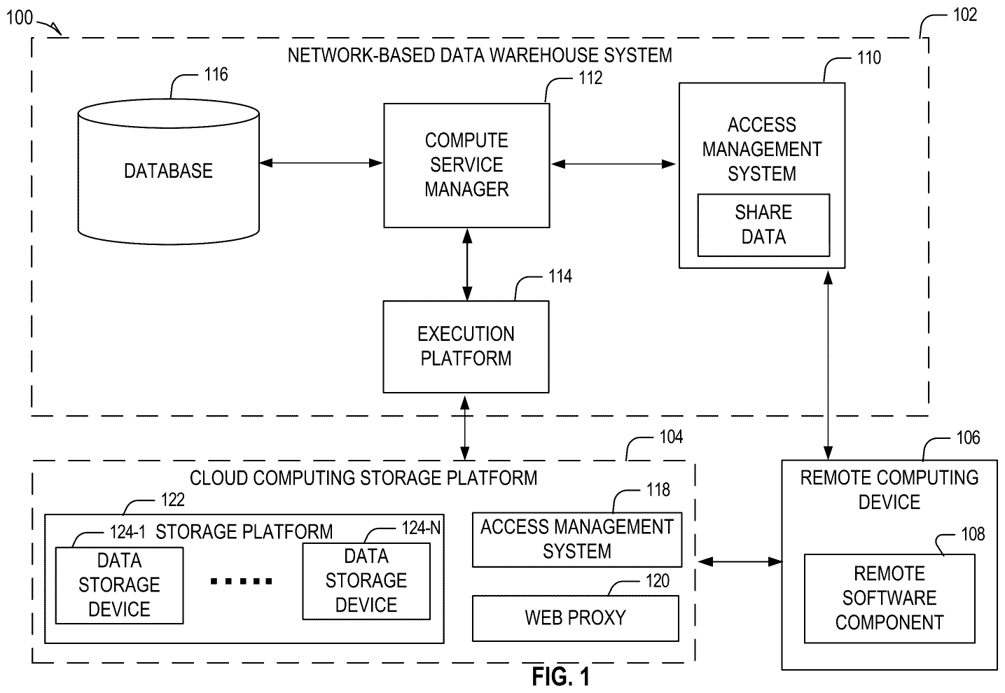

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures.

The network-based database system 102 comprises an access management system 110, a compute service manager 112, an execution platform 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

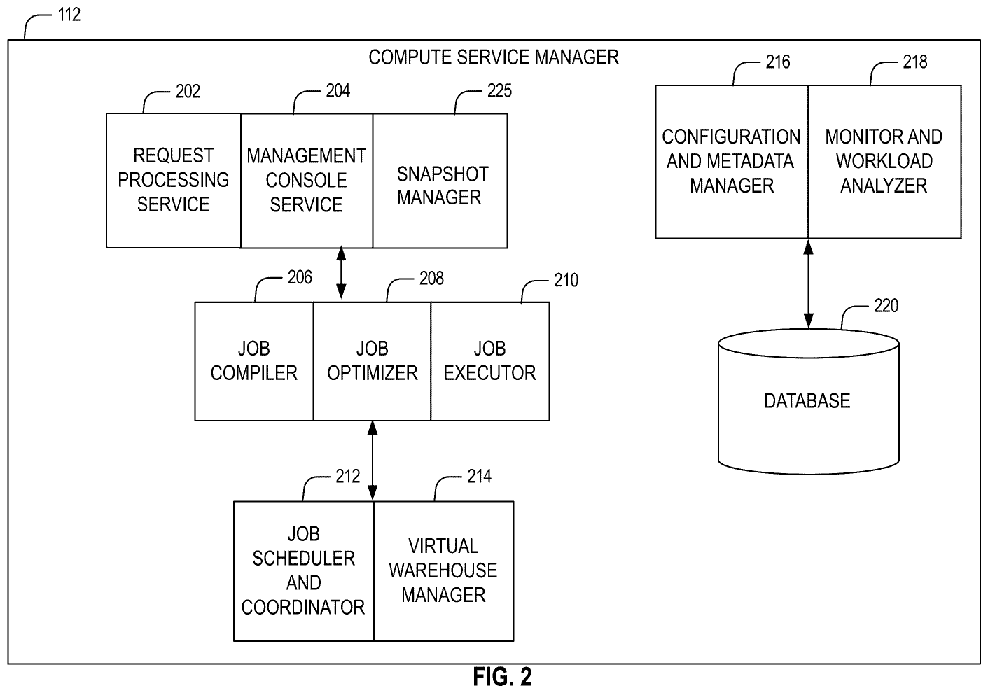

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represent any data storage device within the network-based database system 102. For example, data storage device 220 may represent caches in execution platform 114, storage devices in cloud computing storage platform 104, or any other storage device.

The compute service manager 112 further includes a snapshot manager 225, which creates and manages snapshots of database objects, as described in further detail below. A snapshot may be a copy of database data at a specified time. Snapshots may be generated using cloning operations. The snapshot manager 225 may manage storage of snapshots in different tiered storage locations, as described in further detail below.

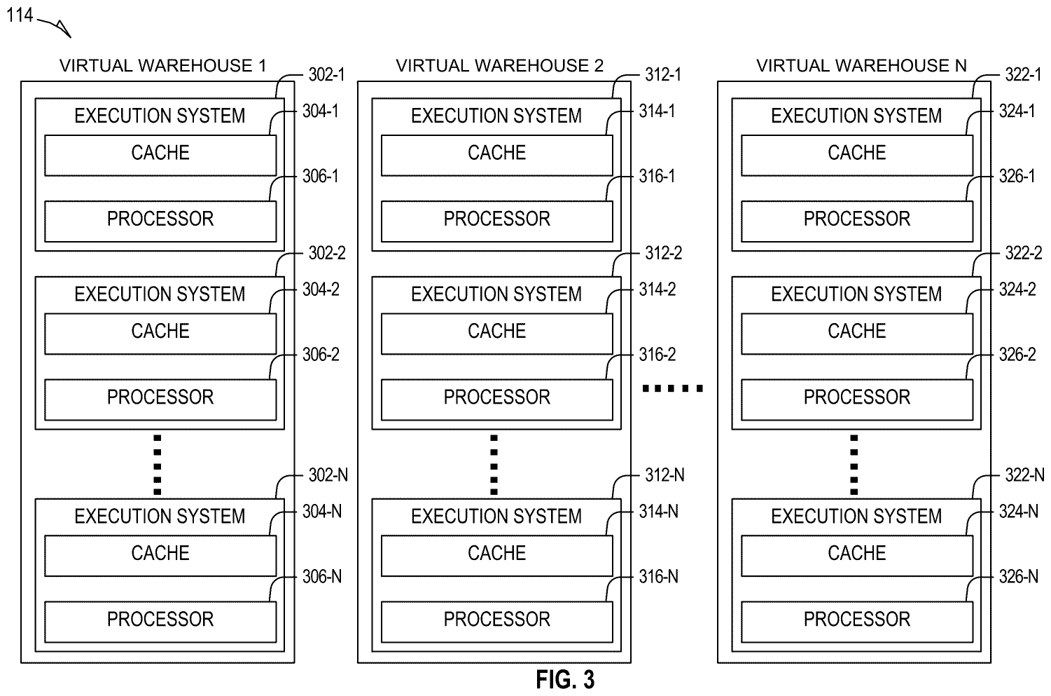

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

A table of a database may include many rows and columns of data. For example, one table may include millions of rows of data and may be very large and difficult to store or read. A very large table may be divided into multiple smaller files which may be referred to herein as “micro-partitions.” For example, one table may be divided into six distinct micro-partitions, and each of the six micro-partitions may include a portion of the data in the table. Dividing the table data into multiple micro-partitions helps to organize the data and to find where certain data is located within the table.

An analogy to the micro-partitions of the table may be different storage buildings within a storage compound. In the analogy, the storage compound is similar to the table, and each separate storage building is similar to a micro-partition. Hundreds of thousands of items are stored throughout the storage compound. Because so many items are located at the storage compound, it is necessary to organize the items across the multiple separate storage buildings. The items may be organized across the multiple separate storage buildings by any means that makes sense. For example, one storage building may store clothing, another storage building may store household goods, another storage building may store toys, and so forth. Each storage building may be labeled so that the items are easier to find. For example, if a person wants to find a stuffed bear, the person will know to go to the storage building that stores toys. The storage building that stores toys may further be organized into rows of shelving. The toy storage building may be organized so that all stuffed animals are located on one row of shelving. Therefore, the person looking for the stuffed bear may know to visit the building that stores toys and may know to visit the row that stores stuffed animals. Further to the analogy with database technology, each row of shelving in the storage building of the storage compound may be similar to a column of database data within a micro-partition of the table. The labels for each storage building and for each row of shelving are similar to metadata in a database context.

Similar to the analogy of the storage compound, the micro-partitions disclosed herein can provide considerable benefits for managing database data, finding database data, and organizing database data. Each micro-partition organizes database data into rows and columns and stores a portion of the data associated with a table. One table may have many micro-partitions. The partitioning of the database data among the many micro-partitions may be done in any manner that makes sense for that type of data. For example, if the database client is a credit card provider and the data is credit card transactions, the table may include columns such as credit card number, account member name, merchant name, date of card transaction, time of card transaction, type of goods or services purchased with card, and so forth. The table may include millions and millions of credit card transactions spanning a significant time period, and each credit card transaction may be stored in one row of the table. Because the table includes so many millions of rows, the table may be partitioned into micro-partitions. In the case of credit card transactions, it may be beneficial to split the table based on time. For example, each micro-partition may represent one day or one week of credit card transactions. It should be appreciated that the table may be partitioned into micro-partitions by any means that makes sense for the database client and for the type of data stored in the table. The micro-partitions provide significant benefits for managing the storage of the millions of rows of data in the table, and for finding certain information in the table.

A database table may store data in a plurality of micro-partitions, wherein the micro-partitions are immutable storage devices. When a transaction is executed on a such a table, all impacted micro-partitions are recreated to generate new micro-partitions that reflect the modifications of the transaction. After a transaction is fully executed, any original micro-partitions that were recreated may then be removed from the database. A new version of the table is generated after each transaction that is executed on the table. The table may undergo many versions over a time period if the data in the table undergoes many changes, such as inserts, deletes, updates, and/or merges. Each version of the table may include metadata indicating what transaction generated the table, when the transaction was ordered, when the transaction was fully executed, and how the transaction altered one or more rows in the table.

In some embodiments, all data in tables is automatically divided into an immutable storage device referred to as a micro-partition. The micro-partition may be considered a batch unit where each micro-partition has contiguous units of storage. By way of example, each micro-partition may contain between 50 MB and 500 MB of uncompressed data (note that the actual size in storage may be smaller because data may be stored compressed). Groups of rows in tables may be mapped into individual micro-partitions organized in a columnar fashion. This size and structure allow for extremely granular selection of the micro-partitions to be scanned, which can be comprised of millions, or even hundreds of millions, of micro-partitions. This granular selection process may be referred to herein as “pruning” based on metadata. Pruning involves using metadata to determine which portions of a table, including which micro-partitions or micro-partition groupings in the table, are not pertinent to a query, and then avoiding those non-pertinent micro-partitions when responding to the query and scanning only the pertinent micro-partitions to respond to the query. Metadata may be automatically gathered about all rows stored in a micro-partition, including: the range of values for each of the columns in the micro-partition; the number of distinct values; and/or additional properties used for both optimization and efficient query processing. In one embodiment, micro-partitioning may be automatically performed on all tables. For example, tables may be transparently partitioned using the ordering that occurs when the data is inserted/loaded.

In some embodiments, metadata is stored and maintained on non-mutable storage services (may be referred to herein as micro-partitions) in the cloud. These storage services may include, for example, Amazon S3®, Microsoft Azure Blob Storage®, and Google Cloud Storage®. Many of these services do not allow to update data in-place (i.e., are non-mutable or immutable). Data micro-partitions may only be added or deleted, but not updated. In some embodiments, storing and maintaining metadata on these services requires that, for every change in metadata, a metadata micro-partition is added to the storage service. These metadata micro-partitions may be periodically consolidated into larger “compacted” or consolidated metadata micro-partitions in the background.

An expression property is some information about the one or more columns stored within one or more micro-partitions. In some embodiments, the expression property includes one or more of: a summary of database data stored in a column, a type of database data stored in a column, a minimum and maximum for database data stored in a column, a null count for database data stored in a column, a distinct count for database data stored in a column, a structural or architectural indication of how data is stored, and so forth.

A cumulative expression property includes global information about data stored in a plurality of expression properties. Similar to the expression property, the cumulative expression property includes any suitable information about database data and/or the database itself. The cumulative expression property may store a summary of the information stored within the plurality of expression properties to which it is associated. In some embodiments, the cumulative expression property includes one or more of: a summary of the data stored across each of one or more micro-partitions of a table, a type of data stored in one or more columns across each of one or more micro-partitions of a table, a global minimum and maximum for data stored across each of one or more micro-partitions of a table, and so forth.

As used herein, immutable or non-mutable storage includes storage where data cannot, or is not permitted, to be overwritten or updated in-place. For example, changes to data that is located in a cell or region of storage media may be stored as a new micro-partition in a different, time-stamped, cell or region of the storage media. Mutable storage may include storage where data is or permitted to be overwritten or updated in place. For example, data in a given cell or region of the storage media can be overwritten when there are changes to the data relevant to that cell or region of the storage media.

In some embodiments, metadata is stored and maintained on non-mutable storage services in the cloud. These storage services may include, for example, Amazon S3®, Microsoft Azure Blob Storage®, and Google Cloud Storage®. Many of these services do not allow to update data in-place (i.e., are non-mutable or immutable). Data micro-partitions may only be added or deleted, but never updated. In some embodiments, storing and maintaining metadata on these services requires that, for every change in metadata, a metadata micro-partition is added to the storage service. These metadata micro-partitions may be periodically consolidated into larger “compacted” or consolidated metadata micro-partitions in the background. A metadata micro-partition version may be stored to indicate metadata micro-partitions that correspond to the compacted or consolidated version versus the pre-compaction or pre-consolidation version of metadata micro-partitions. In some embodiments, consolidation of mutable metadata in the background to create new versions of metadata micro-partitions may allow for deletions of old metadata micro-partitions and old data micro-partitions.

By using immutable storage, such as cloud storage, embodiments allow storage capacity to not have a hard limit. Using storage services in the cloud allows for virtually unlimited amounts of metadata. Reading large amounts of metadata may be much faster because metadata micro-partitions may be downloaded in parallel, including prefetching of micro-partitions. Metadata micro-partitions may also be cached on a local micro-partition system so that they are not downloaded more than once.

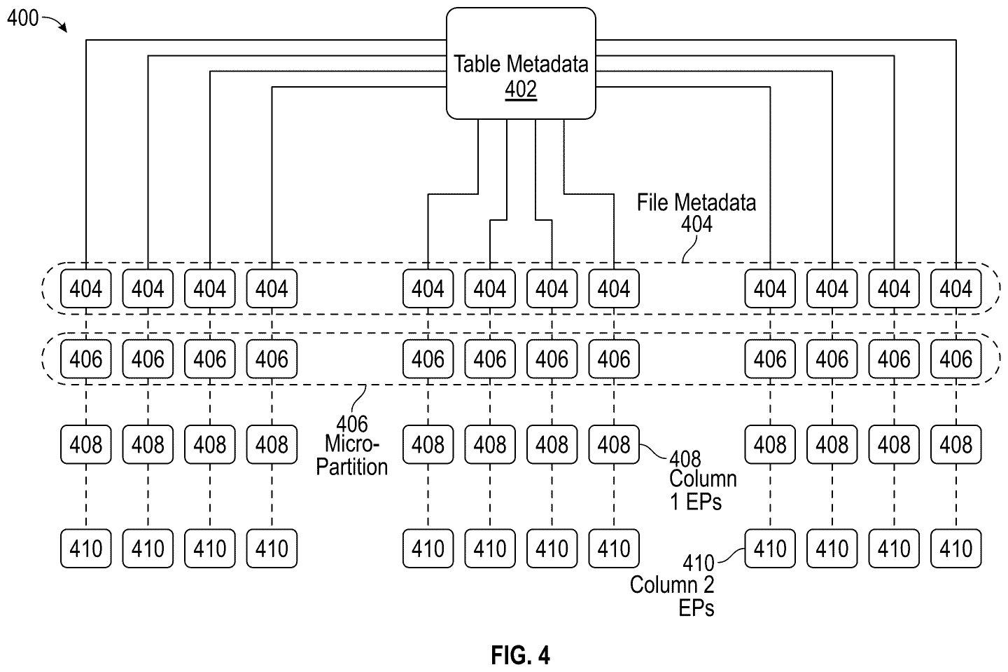

FIG. 4 is a schematic diagram of a data structure 400 for storage of database metadata, according to some example embodiments. The data structure 400 may be constructed from metadata micro-partitions, as described above, and may be stored in a metadata cache memory. The data structure 400 includes table metadata 402 pertaining to database data stored across a table of the database. The table may be composed of multiple micro-partitions serving as immutable storage devices that cannot be updated in-place. Each of the multiple micro-partitions may include numerous rows and columns making up cells of database data. The table metadata 402 may include a table identification and versioning information indicating, for example, how many versions of the table have been generated over a time period, which version of the table includes the most up-to-date information, how the table was changed over time, and so forth. A new table version may be generated each time a transaction is executed on the table, where the transaction may include a DML statement such as an insert, delete, merge, and/or update command. Each time a DML statement is executed on the table, and a new table version is generated, one or more new micro-partitions may be generated that reflect the DML statement.

The table metadata 402 includes global information about the table of a specific version. The data structure 400 further includes file metadata 404 (also referred to as micro-partition metadata) that includes metadata about a micro-partition of the table. The terms file and micro-partition may each refer to a subset of database data and may be used interchangeably in some embodiments. The file metadata 404 includes information about a micro-partition 406 of the table. The micro-partition 406 illustrated in FIG. 4 includes database data and is not part of the metadata storage. Further, metadata may be stored for each column of each micro-partition 406 of the table. The metadata pertaining to a column of a micro-partition 406 may be referred to as an expression property (EP) and may include any suitable information about the column, including for example, a minimum and maximum for the data stored in the column, a type of data stored in the column, a subject of the data stored in the column, versioning information for the data stored in the column, file statistics for all micro-partitions in the table, global cumulative expressions for columns of the table, and so forth. Each column of each micro-partition 406 of the table may include one or more expression properties. The table metadata 402 includes expression properties for column 1 of a micro-partition 406 at 408 and expression properties for column 2 of a micro-partition 406 at 410. It should be appreciated that the table may include any number of micro-partitions, and each micro-partition may include any number of columns. The micro-partitions may have the same or different columns and may have different types of columns storing different information.

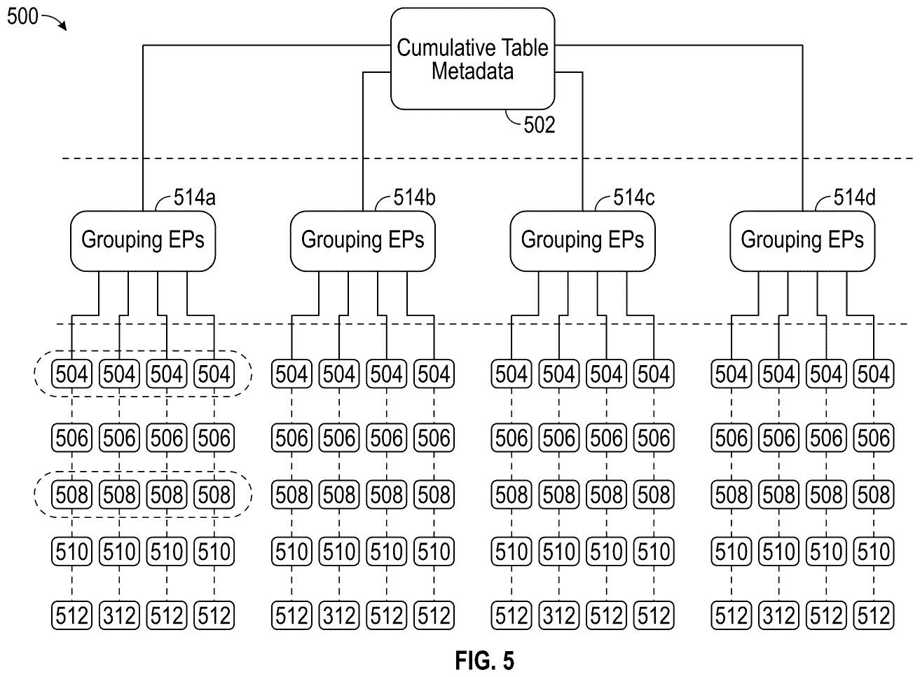

FIG. 5 is a schematic diagram of a data structure 500 for storage of database metadata, including in persistent storage and cache storage, according to some example embodiments. The data structure 500 includes cumulative table metadata 502 including information about a table of the database. The table may include a plurality of files or micro-partitions that may each include a number of columns and rows storing database data. The cumulative table metadata 502 includes global information about the table and may include summary information stored in each of a plurality of grouping expression properties 514a, 514b, 514c, and 514d (may be collectively referenced herein as “514”). The grouping expression properties 514 include aggregated micro-partition statistics, cumulative column properties, and so forth about a micro-partition 506 or a collection of micro-partitions of the table. It should be appreciated that the micro-partitions 506 illustrated in FIG. 5 may each contain a different subset of the data stored in the table and may include the same columns or may include different columns storing different types of information. The micro-partitions 506 of the table each include one or more columns and may each have the same types of columns or different types of columns. An expression property may be stored for each column of each micro-partition 506 of the table, or for a collection of micro-partitions 506 of the table as illustrated in FIG. 5. The data structure 500 includes micro-partition statistics 504 for each micro-partition 506 of the table (the micro-partition statistics 504 may alternatively be referred to herein as “micro-partition expression properties”). The micro-partition statistics 504 may include a minimum/maximum data point for the corresponding micro-partition 506, a type of data stored in the corresponding micro-partition, a micro-partition structure of the corresponding micro-partition 506, and so forth. As illustrated in FIG. 5, a column 1 expression property 508 is stored for the first column in each of the different micro-partitions 506. Further, a column 2 expression property 510 is stored for the second column in each of the different micro-partitions 506. In addition, a column 3 expression property 512 is stored for the third column in each of the different micro-partitions. It should be appreciated that each of the micro-partitions may include any suitable number of columns, and that an expression property may be stored for each of the columns, or for any suitable number of the columns, stored in each micro-partition of the table. The column 1 expression properties 508, the column 2 expression properties 510, and the column 3 expression properties 512, along with any additional column expression properties that may be included as deemed appropriate, may be stored as part of a metadata micro-partition. A metadata micro-partition may be persisted in immutable storage and the grouping expression properties 514 may also be stored within a metadata micro-partition in immutable storage. A metadata manager may maintain all metadata micro-partitions, including metadata micro-partitions comprising the grouping expression properties 514, and micro-partition statistics 504, and/or the column expression properties 508-512.

The cumulative table metadata 502 includes global information about all micro-partitions within the applicable table. For example, the cumulative table metadata 502 may include a global minimum and global maximum for the entire table, which may include millions or even hundreds of millions of micro-partitions. The cumulative table metadata 502 may include any suitable information about the data stored in the table, including, for example, minimum/maximum values, null count, a summary of the database data collectively stored across the table, a type of data stored across the table, a distinct for the data stored in the table, and so forth.

The grouping expression properties 514a-514d include information about database data stored in an associated grouping of micro-partitions. For example, an example grouping expression property is associated with micro-partitions numbered 3040 thru 3090 such that the example grouping expression property is associated with fifty different micro-partitions. The example grouping expression property includes information about those fifty different micro-partitions. A grouping expression property 514 may include any suitable information about the micro-partitions with which it is associated. For example, a grouping expression property 514 may include a global minimum/maximum for the collective set of micro-partitions, a minimum/maximum for each of the micro-partitions within the grouping, a global null count, a null count for each of the micro-partitions within the grouping, a global summary of data collectively stored across the grouping of micro-partitions, a summary of data stored in each of the micro-partitions in the grouping, and so forth. The global expression property 514 may include global information for all micro-partitions within the grouping of micro-partitions that is associated with the grouping expression property 514, and it may further include information specific to each of the micro-partitions within the associated grouping.

The metadata structure disclosed in FIG. 5 provides increased granularity in cumulative table metadata 502. The grouping expression properties 514 provide valuable global metadata pertaining to a collection of micro-partitions 506 of the database. Further, each of the columnar expression properties 508, 510, 512 provide valuable information about a column of a micro-partition 506 of the table.

The metadata structures disclosed herein, including the data structure 500 shown in FIG. 5, increases efficiency when responding to database queries. A database query may request any collection of data from the database and may be used for created advanced analyses and metrics about the database data. Some queries, particularly for a very large database, can be extremely costly to run both in time and computing resources. When it is necessary to scan metadata and/or database data for each file or micro-partition of each table of a database, it can take many minutes or even hours to respond to a query. In certain implementations, this may not be an acceptable use of computing resources. The data structure 500 disclosed herein provides increased metadata granularity and enables multi-level pruning of database data. During compilation and optimization of a query on the database, a processor may scan the cumulative table metadata 502 to determine if the table includes information pertaining to the query. In response to determining, based on the cumulative table metadata 502, that the table includes information pertaining to the query, the processor may scan each of the grouping expression properties 514 to determine which grouping of micro-partitions of the table include information pertaining to the query. In response to determining, based on a first cumulative expression property, that a first grouping of micro-partitions does not include information pertaining to the query, the processor may discontinue database scanning of that first grouping of micro-partitions. In response to determining, based on a second cumulative expression property, that a second grouping of micro-partitions includes information pertaining to the query, the processor may proceed to scan expression properties for that second grouping of micro-partitions. The processor may efficiently determine which micro-partitions include pertinent data and which columns of which micro-partitions include pertinent data. The processor may proceed to scan only the relevant column(s) and micro-partition(s) that include information relevant to a database query. This provides a cost-efficient means for responding to a database query by way of multi-level pruning based on multi-level table metadata.

Further to increase the cost efficiency of database queries, a compute service manager may store the cumulative table metadata 502 in a cache for faster retrieval. Metadata for the database may be stored in a metadata store separate and independent of a plurality of shared storage devices collectively storing database data. In a different embodiment, metadata for the database may be stored within the plurality of shared storage devices collectively storing database data. In various embodiments, metadata may be stored in metadata-specific micro-partitions that do not include database data, and/or may be stored within micro-partitions that also include database data. The metadata may be stored across disk storage, such as the plurality of shared storage devices, and it may also be stored in cache within the compute service manager.

Users may want to create archive copies of their data. For example, users may want to create copies of tables periodically, for example, for regulatory purposes. Some industry regulations require data to be maintained for a specified time.

One technique for archiving data is snapshots. A snapshot can include a copy of table data at a specified time. A snapshot includes a schema of a table (e.g., column definitions) and the data in the table at the specified time. Users can use a “create snapshot” command to generate a snapshot of specified data. Snapshots can be used to recreate table data at a specified time. For example, a user can generate snapshots of table data every day. The snapshots can be individually saved. Hence, the user can use the snapshots to recreate the state of the table on a specified day in the past.

Snapshots can be generated using cloning operations. When the data system generates a snapshot, the data system may generate a new snapshot object in the metadata database. The system may then run a clone-like operation on the database and nest the cloned database under the snapshot object. While the snapshot object is visible to the user, the cloned database is not directly visible to the user but is a nested, hidden object under the snapshot object.

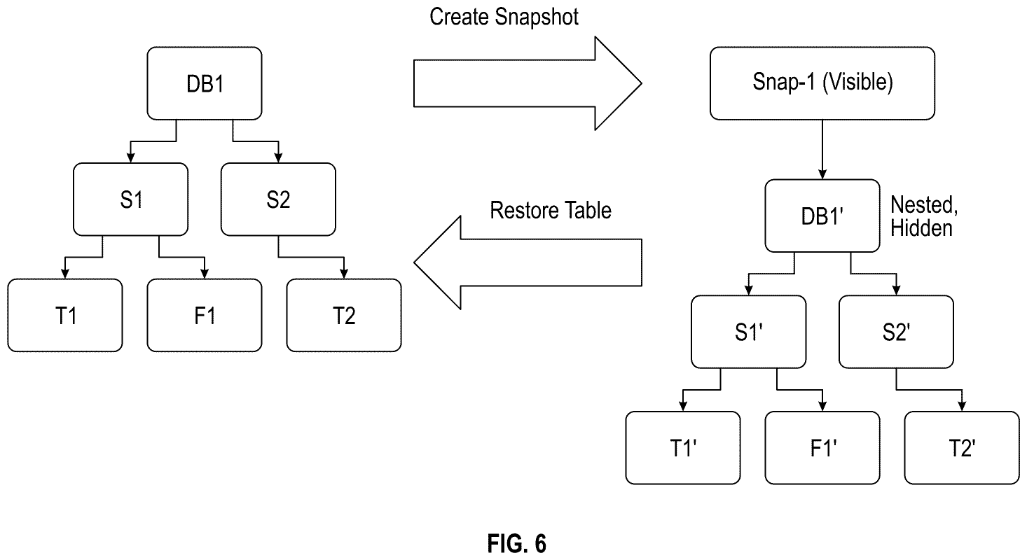

FIG. 6 shows an example of using a snapshot to archive database data, according to some example embodiments. In FIG. 6, a database (DB1) is stored in the data system using the storing techniques described herein. DB1 may include two schemas, S1 and S2. S1 may include table T1 and function F1. S2 may include a table T2.

The data system may create a snapshot (Snap1) of DB1 to capture the contents of DB1 at a specified time. Snap1 may be a database object stored in the metadata database. Snap1 may include information of when the snapshot was created. The Snap1 object may be visible to the user.

Cloned copies of DB1 may be nested under Snap1 and may be hidden from the user. For example, DB1′ represents a cloned version of DB1. S1′, T1′, and F1′ may represent cloned versions of S1, T1, and F1, respectively. Likewise, S2′ and T2′ may represent cloned versions of S2 and T2. To restore the snapshot, the data system may run the process in reverse. That is, the data system may clone the nested DB1′ into a visible table.

Snapshots can be generated on a frequent basis, such as every hour, day, etc. Therefore, storage costs can increase quite rapidly when storing numerous snapshots. Next, techniques for storing snapshots in different tiered storages to reduce storage costs are described.

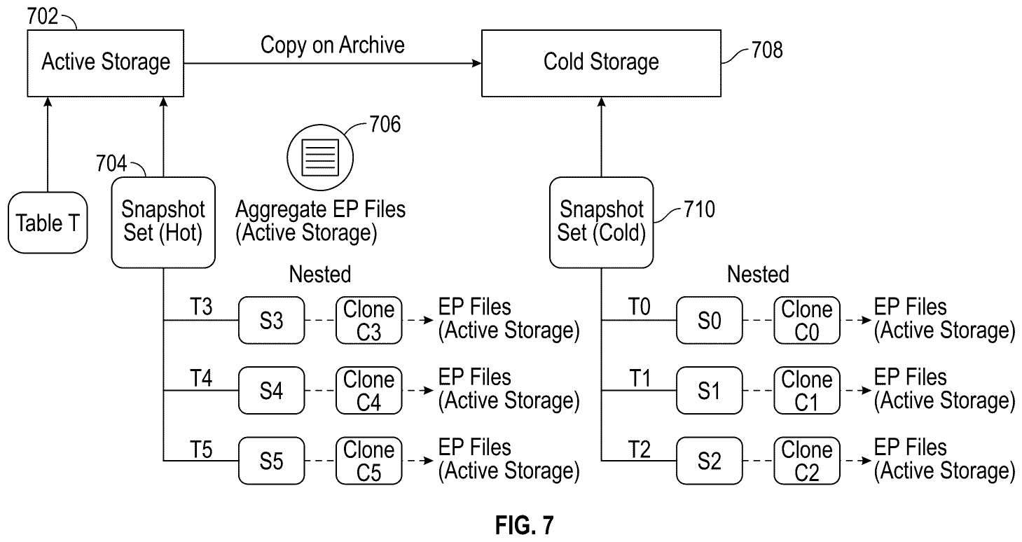

FIG. 7 shows a network flow of storing snapshots in different tiered storage locations, according to some example embodiments. In this example, a table T is stored in the data system using the storing techniques described herein. Table T may include data organized in a plurality of micro-partitions, as described above. A user may set a snapshot creation command to take snapshots of table T periodically, such as every hour, day, etc.

Initially, snapshots may be stored in active storage 702. Active storage 702 may refer to a first-tier storage where retrieval time is relatively fast. In some examples, active storage 702 may correspond to standard storage options provided by different cloud service providers.

A (hot) snapshot set 704 for table T is stored in the active storage 702. The snapshot set 704 may include a set of the most recent snapshots taken of table T. As explained in further detail below, older snapshots are transferred to a second-tier storage to reduce storage costs. In this example, the snapshot set 704 includes snapshot S3 taken at time T3, snapshot S4 taken at time T4, and snapshot S5 taken at time T5. S3-S5 are database objects visible to the user.

Underneath each snapshot, cloned versions of the table at the time the respective snapshots are nested. The nested objects are related to the respective snapshots in a hierarchical manner, and the nested objects are hidden from the users. Nested underneath S3 is cloned table C3, nested underneath S4 is cloned table C4, and nested underneath S5 is cloned table C5. The cloned tables are hidden from the user. For each cloned table C3-C5, EP files, as described above, are stored in the active storage 702.

The use of cloned files further reduces storage costs. Snapshots in the (hot) snapshot set 704 share data files with the active table (T). The snapshots are time ordered. When a new snapshot is generated, only additional files not in the previous snapshot in the snapshot set 704 are linked. The files present in the previous snapshot are shared with the new snapshot and do not need to be re-saved.

In addition to the EP files stored with the respective cloned tables, a list of aggregate EP files 706 is also stored for the snapshots currently in the (hot) snapshot set 704. The aggregate EP files 706 includes a list of EP files representing the aggregate state (union) of the snapshots currently stored in the snapshot set 704. In this example, the aggregate EP files 706 includes the EP files for snapshots S3-S5. The aggregate EP files 706 provides benefits, such as faster processing of fail-safe operations, as described in further below.

After a specified time, data objects from (hot) snapshot set 704 may be moved from active storage 702 to cold storage 708. As discussed below, the EP files may remain in active storage 702. EP files may also be regenerated in the cold storage 708 for the moved data files. Cold storage 708 may refer to a lower tier storage (e.g., second tier) as compared to active storage 702. For example, retrieval time from cold storage 708 may be slower than the retrieval time from the active storage 702. Cold storage 708 may be less costly than active storage 702.

A (cold) snapshot set 710 for table T is stored in the cold storage 708. The snapshot set 710 may include a set of snapshots taken of table T, which were moved from active storage 702 after a specified time. For example, a user may set a time limit of 30 days of storing snapshots in the active storage 702. Once a respective snapshot has reached its time limit, that snapshot is transferred from active storage 702 to cold storage 708. In this example, the snapshot set 710 includes snapshot S0 taken at time TO, snapshot S1 taken at time T1, and snapshot S2 taken at time T2. S0 corresponds to the first snapshot taken of table T, and S2 is the most recent snapshot transferred from active storage 702. S0-S2 are database objects visible to the user.

Underneath each snapshot, cloned versions of the table at the time the respective snapshots are provided. Nested underneath S0 is cloned table C0, nested underneath S1 is cloned table C1, and nested underneath S2 is cloned table C2. The cloned tables are hidden from the user. For each cloned table C0-C2, EP files, as described above, are stored in the active storage 702, not cold storage 708.

The EP files are used for processing operations, as described in further detail below, so having the EP files stored in the active storage 702 makes the processing faster. No aggregate list of EP files for the snapshots in (cold) snapshot set 710 in cold storage 708 is kept unlike the aggregate EP files 706 for the snapshots in (hot) snapshot set 704 in active storage 702.

When a snapshot is archived into the cold storage 708, data files are copied into the cold storage 708, and the serialized metadata objects (e.g., EP files) are regenerated in the cold storage 708. Files can be shared between different snapshots in the (cold) snapshot set 710 in cold storage 708. For example, if S2 includes a file already saved in S1, then that file is not re-saved for S2 but instead shared between S1 and S2. However, files are not shared between (cold) snapshot set 710 in cold storage 708 and the (hot) snapshot set 704 (and active table T) in active storage 702.

As mentioned above, the aggregate EP files 706 assist with faster processing of operations. For example, aggregate EP files 706 can be used for failsafe purposes, and the data system can run system patches and EP file patches on them.

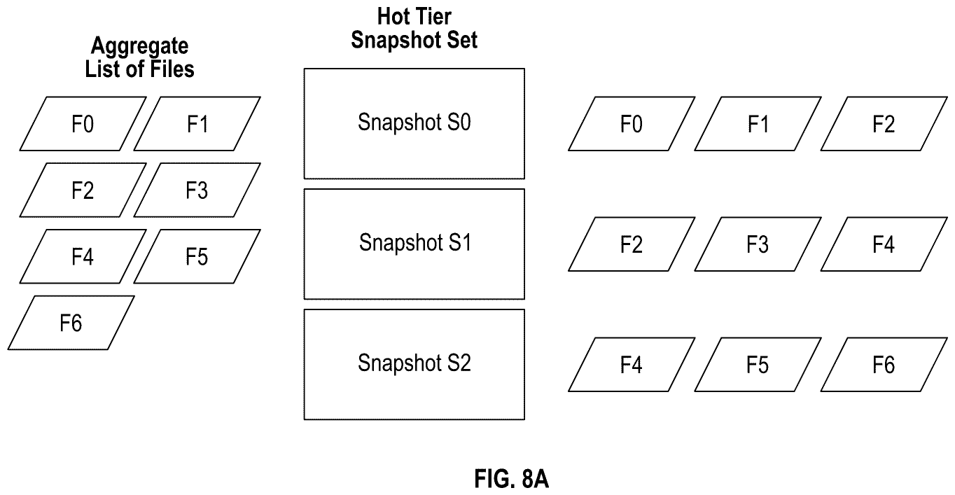

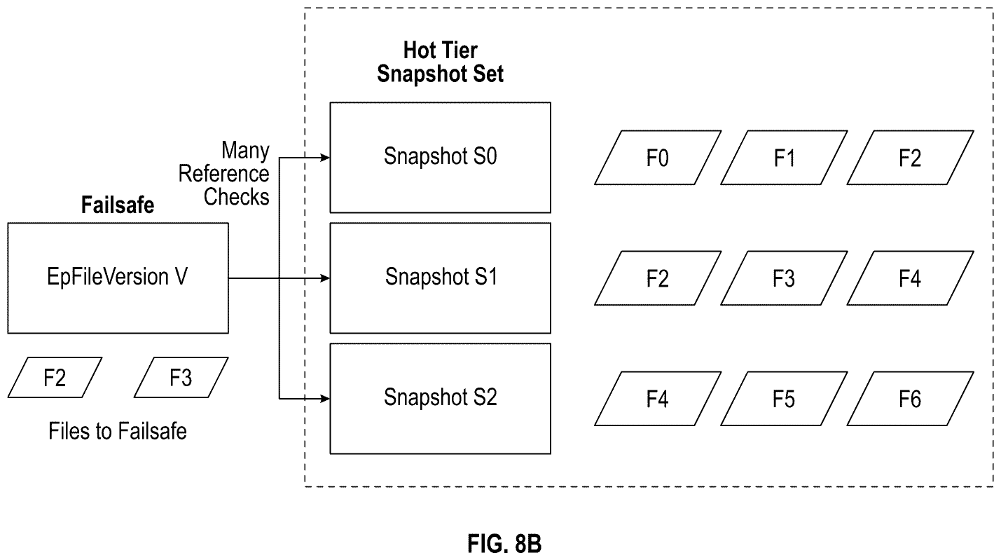

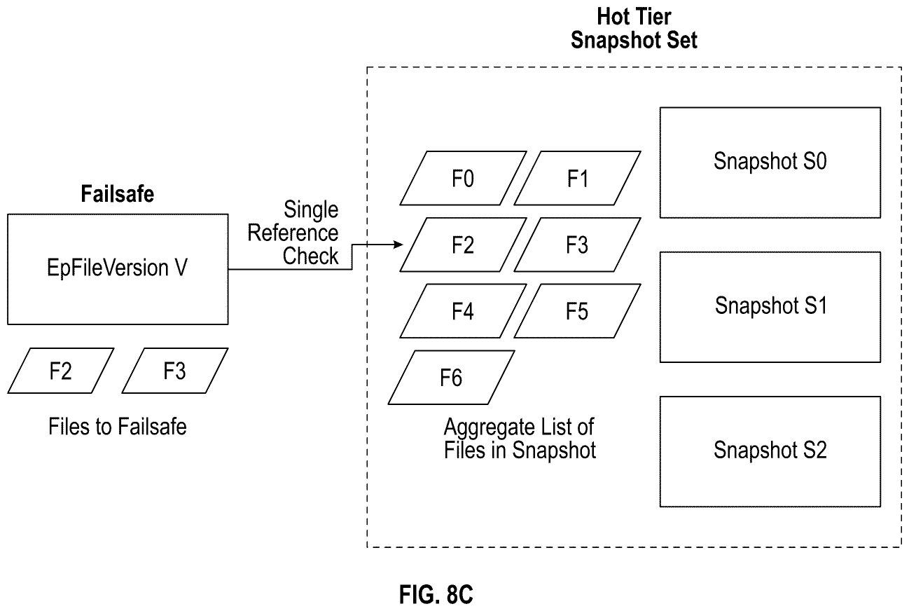

FIGS. 8A-8C shows an example of using an aggregate list of EP files, according to some example embodiments. FIG. 8A shows an example of a hot snapshot tier and corresponding aggregate list of EP files. In this example, a hot tier snapshot includes snapshots S0, S1, and S2. S0 includes files F0, F1, and F2 (which are represented as the EP files) here. S1 includes files F2, F3, and F4. S2 includes files F4, F5, and F6. Therefore, the aggregate list of EP files includes F0-F6, listing all files in snapshots S0-S2. As mentioned above, because the snapshots included nested cloned versions of the table, the data files are shared with the active table and are not copied separately for the snapshots.

Now, consider an example where the data system goes to delete files F2 and F3 from active storage since the most recent version of the active table T no longer includes files F2 and F3. However, file F2 is shared with snapshots S0 and S1, and file F3 is shared with snapshot S1. Therefore, the data system cannot delete files F2 and F3 without generating an error for the stored snapshots. Accordingly, the data system may perform a failsafe operation for a reference check against the snapshots in the hot snapshot set before deleting the files.

FIG. 8B shows if no aggregate list of EP files is provided. Here, the data system must perform numerous reference checks. That is, the system must perform a separate reference check for each snapshot in the hot snapshot set.

FIG. 8C shows the use of the list of EP files to perform the reference check. As illustrated, a single reference check against the aggregate list of EP files is performed for the failsafe operation instead of the numerous reference checks if no aggregate list of EP files was provided. Based on the single reference check, the data system can determine that files F2 and F3 are being used by snapshot in the hot set and therefore cannot be deleted.

Techniques for adding and removing snapshots to the hot snapshot set are described next. To add a new snapshot to the hot snapshot set, a created-on time is used to check for new files. To remove a snapshot from the hot snapshot set to the cold snapshot set in cold storage, a difference (also referred to as diff) operation is used.

Consider the example of FIG. 8A. A new snapshot S3 is to be added to the hot snapshot set. S3 includes files F6, F7, and F8. When taking a snapshot, a create-on time is saved (e.g., dmlStartTime). Hence, a created-on time for the previous snapshot S2 is stored. The system compares the created-on time for the files (e.g., F6, F7, and F8) in S3 with the created-on time for the snaphsot S2. Files with a greater created-on time are added to the aggregate list of EP files while files with an earlier created-on time are not added. In the example, F7 and F8 are added while F6 is not added.

Now, consider that snapshot S0 is to be moved to cold storage for archival. For removal from active storage, the data system performs a diff operation with the next in time snapshot, which in this example is S1. The diff operation, such as diff (S0,S1) determines which files are in S0 but not in S1. In example, diff (S0,S1)={F0, F1}. After the data files and metadata files are copied to cold storage, files F0 and F1 are removed from the aggregate list of files and can be deleted.

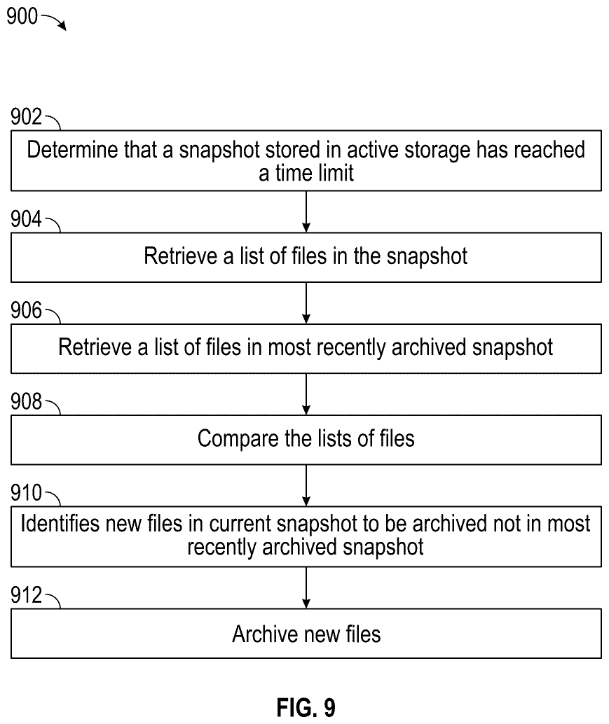

FIG. 9 shows a flow diagram of a method 900 for archiving a snapshot in a second-tier storage, according to some example embodiment. At operation 902, the system determines that a snapshot (e.g., S3) stored in a hot snapshot set in active storage has reached its time limit. At operation 904, the system retrieves a list of files in the snapshot (e.g., S3) stored in active storage. At operation 906, the system retrieves a list of files in the most recently archived snapshot (e.g., S2). The list of files of S2 is stored in active storage, not cold storage, as described above. At operation 908, the system compares the list of files in the current snapshot to be archived with the list of files in the most recently archived snapshot. At operation 910, the system identifies new files in the current snapshot to be archived, not in the most recently archived snapshot based on the comparison. At operation 912, the identified new files are archived. The identified new data files and metadata files are copied to cold storage.

Restoring a table from a hot snapshot is described above with reference to FIG. 6. Restoring a table from snapshot stored in cold storage may include additional steps and may take longer than restoring a table from snapshots stored in active storage.

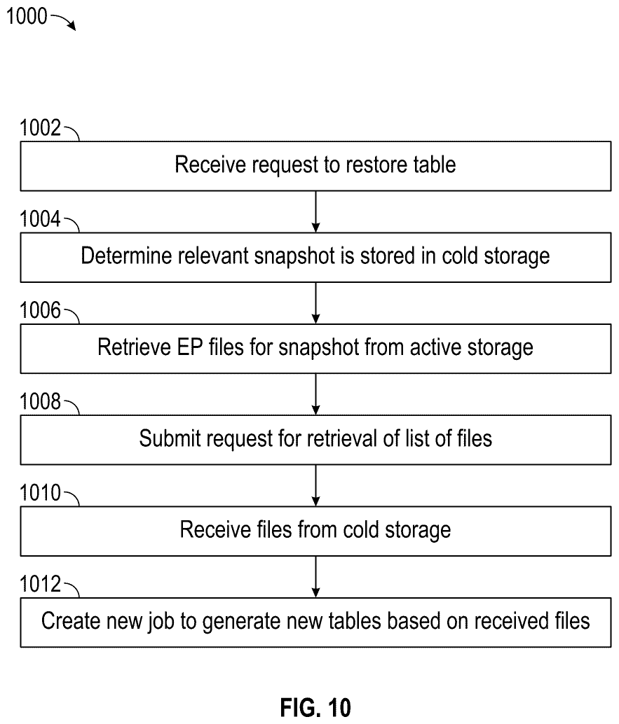

FIG. 10 shows a flow diagram of a method 1000 for restoring a table for a snapshot stored in a second-tier storage, according to some example embodiment. In some examples, a compute service manager, as described above, performs the method 1000. At operation 1002, a request to restore a table is received. The request may include a time value for the table. For example, a compute service manager may receive the request to restore the table from a user for a particular time (e.g., 45 days ago). At operation 1004, the compute service manager determines that the snapshot to restore the requested time value is stored in cold storage (i.e., second-tier storage). At operation 1006, EP files for the cold snapshot are retrieved from active storage. A list of files in the cold snapshot to restore the table is generated based on the EP files for the snapshot. At operation 1008, a request for retrieval of the list of files in the snapshot is submitted to the cold storage. For example, the compute service manager may transmit the request to cold storage. Retrieval from cold storage can take a prolonged time, such as hours. At operation 1010, the files are received from the cold storage and stored in a temporary location. At operation 1012, a new job is created to generate a new table by scanning the data from the restored files from the cold storage.

Some industry regulations may require that archive copies of data cannot be deleted or modified. In some examples, snapshots may be set as immutable. That is, once a snapshot is generated, it cannot be deleted even by an administrator. A property controlling the immutability of the snapshot may be set when the system schedules the snapshot generation.

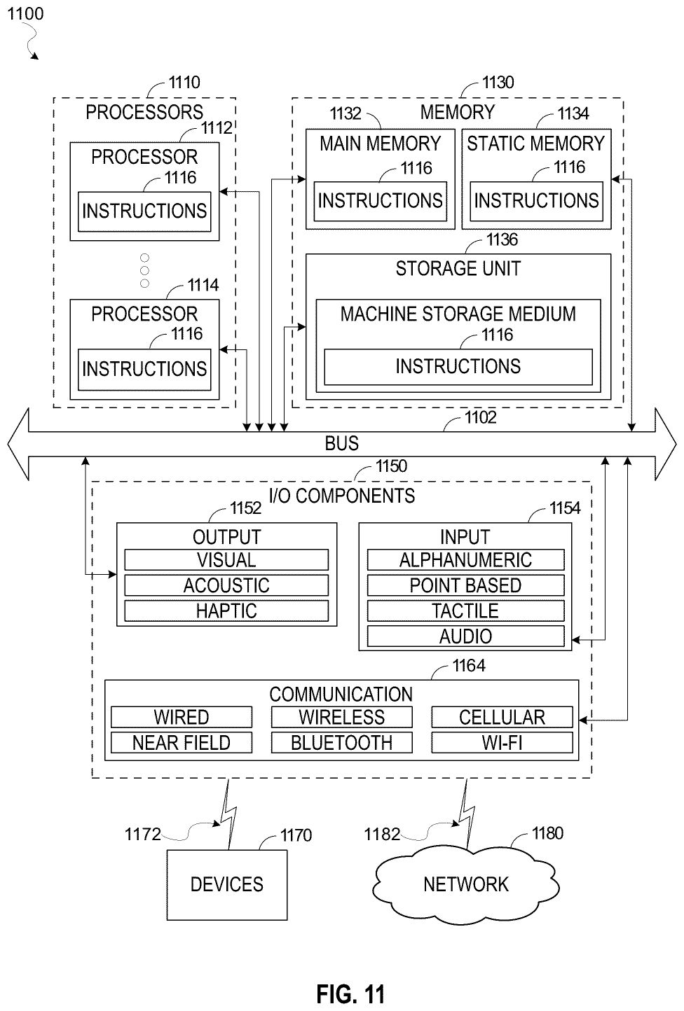

FIG. 11 illustrates a diagrammatic representation of a machine 1100 in the form of a computer system within which a set of instructions may be executed for causing the machine 1100 to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute any one or more operations of any one or more of the methods described herein (e.g., method 900 and method 1000). As another example, the instructions 1116 may cause the machine 1100 to implement portions of the data flows described herein. In this way, the instructions 1116 transform a general, non-programmed machine into a particular machine 1100 (e.g., the remote computing device 106, the access management system 118, the compute service manager 112, the execution platform 114, the access management system 110, the Web proxy 120, remote computing device 106) that is specially configured to carry out any one of the described and illustrated functions in the manner described herein.

In some embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 includes processors 1110, memory 1130, and input/output (I/O) components 1150 configured to communicate with each other such as via a bus 1102. In an example embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors 1110 that may comprise two or more independent processors (sometimes referred to as “cores”) that may execute instructions 1116 contemporaneously. Although FIG. 11 shows multiple processors 1110, the machine 1100 may include a single processor with a single core, a single processor with multiple cores (e.g., a multi-core processor), multiple processors with a single core, multiple processors with multiple cores, or any combination thereof.

The memory 1130 may include a main memory 1132, a static memory 1134, and a storage unit 1136, all accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 include components to receive input, provide output, produce output, transmit information, exchange information, capture measurements, and so on. The specific I/O components 1150 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, and other communication components to provide communication via other modalities. The devices 1170 may be another machine or any of a wide variety of peripheral devices (e.g., a peripheral device coupled via a universal serial bus (USB)). For example, as noted above, the machine 1100 may correspond to any one of the remote computing device 106, the access management system 118, the compute service manager 112, the execution platform 114, the access management system 110, the Web proxy 120, and the devices 1170 may include any other of these systems and devices.

The various memories (e.g., 1130, 1132, 1134, and/or memory of the processor(s) 1110 and/or the storage unit 1136) may store one or more sets of instructions 1116 and data structures (e.g., software) embodying or utilized by any one or more of the methodologies or functions described herein. These instructions 1116, when executed by the processor(s) 1110, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1180 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.
Example 1. A method comprising: receiving a command to generate a snapshot of a table stored in a data system, the table comprising a plurality of partitions; generating, by at least one hardware processor, a first snapshot object based on the command, the first snapshot object being visible to a user having access to the table; cloning the table to generate a cloned version of the table; storing the snapshot object in a first snapshot set in a first-tier storage, the first snapshot set comprising a first set of snapshot objects; storing the cloned version of the table as a nested, hidden object underneath the snapshot object in the first-tier storage; storing expression property (EP) files for the plurality of partition files with the snapshot object in the first snapshot set in the first-tier storage; and storing an aggregate list of EP files of current snapshot objects in the first snapshot set in first-tier storage.
Example 2. The method of example 1, wherein at least one data file in the table and the cloned version of the table are shared in the first-tier storage.
Example 3. The method of any of examples 1-2, wherein the first snapshot object and a second snapshot object in the first snapshot set share a first EP file corresponding to a partition shared by the first snapshot and second snapshot.
Example 4. The method of any of examples 1-3, further comprising: determining that an archival time for the first snapshot object has expired; and transferring the first snapshot object from active storage to a second-tier storage.
Example 5. The method of any of examples 1-4, wherein retrieval times for the first-tier storage are shorter than retrieval times for the second-tier storage.
Example 6. The method of any of examples 1-5, wherein transferring the first snapshot object comprises a second cloned version of the table nested underneath the first snapshot object in the second-tier storage, wherein the second cloned version is hidden from the user.
Example 7. The method of any of examples 1-6, wherein EP files for the first snapshot object in the second-tier storage are stored in the active storage.
Example 8. A system comprising: one or more processors of a machine; and a memory storing instructions that, when executed by the one or more processors, cause the machine to perform operations implementing any one of example methods 1 to 7.
Example 9. A machine-readable storage device embodying instructions that, when executed by a machine, cause the machine to perform operations implementing any one of example methods 1 to 7.

What is claimed is:

1. A method comprising:
receiving a command to generate a snapshot of a table stored in a data system, the table comprising a plurality of partitions;
generating, by at least one hardware processor, a first snapshot object based on the command, the first snapshot object being visible to a user having access to the table;
cloning the table to generate a cloned version of the table;
storing the snapshot object in a first snapshot set in a first-tier storage, the first snapshot set comprising a first set of snapshot objects;
storing the cloned version of the table as a nested, hidden object underneath the snapshot object in the first-tier storage;
storing expression property (EP) files for the plurality of partition files with the snapshot object in the first snapshot set in the first-tier storage; and
storing an aggregate list of EP files of current snapshot objects in the first snapshot set in first-tier storage.

2. The method of claim 1, wherein at least one data file in the table and the cloned version of the table are shared in the first-tier storage.

3. The method of claim 1, wherein the first snapshot object and a second snapshot object in the first snapshot set share a first EP file corresponding to a partition shared by the first snapshot and second snapshot.

4. The method of claim 1, further comprising:
determining that an archival time for the first snapshot object has expired; and
transferring the first snapshot object from active storage to a second-tier storage.

5. The method of claim 4, wherein retrieval times for the first-tier storage are shorter than retrieval times for the second-tier storage.

6. The method of claim 4, wherein transferring the first snapshot object comprises a second cloned version of the table nested underneath the first snapshot object in the second-tier storage, wherein the second cloned version is hidden from the user.

7. The method of claim 4, wherein EP files for the first snapshot object in the second-tier storage are stored in the active storage.

8. A machine-storage medium embodying instructions that, when executed by a machine, cause the machine to perform operations comprising:
receiving a command to generate a snapshot of a table stored in a data system, the table comprising a plurality of partitions;
generating, by at least one hardware processor, a first snapshot object based on the command, the first snapshot object being visible to a user having access to the table;
cloning the table to generate a cloned version of the table;
storing the snapshot object in a first snapshot set in a first-tier storage, the first snapshot set comprising a first set of snapshot objects;
storing the cloned version of the table as a nested, hidden object underneath the snapshot object in the first-tier storage;
storing expression property (EP) files for the plurality of partition files with the snapshot object in the first snapshot set in the first-tier storage; and
storing an aggregate list of EP files of current snapshot objects in the first snapshot set in first-tier storage.

9. The machine-storage medium of claim 8, wherein at least one data file in the table and the cloned version of the table are shared in the first-tier storage.

10. The machine-storage medium of claim 8, wherein the first snapshot object and a second snapshot object in the first snapshot set share a first EP file corresponding to a partition shared by the first snapshot and second snapshot.

11. The machine-storage medium of claim 8, further comprising:
determining that an archival time for the first snapshot object has expired; and
transferring the first snapshot object from active storage to a second-tier storage.

12. The machine-storage medium of claim 11, wherein retrieval times for the first-tier storage are shorter than retrieval times for the second-tier storage.

13. The machine-storage medium of claim 11, wherein transferring the first snapshot object comprises a second cloned version of the table nested underneath the first snapshot object in the second-tier storage, wherein the second cloned version is hidden from the user.

14. The machine-storage medium of claim 11, wherein EP files for the first snapshot object in the second-tier storage are stored in the active storage.

15. A system comprising:
at least one hardware processor; and
at least one memory storing instructions that, when executed by the at least one hardware processor, cause the at least one hardware processor to perform operations comprising:
receiving a command to generate a snapshot of a table stored in a data system, the table comprising a plurality of partitions;
generating, by at least one hardware processor, a first snapshot object based on the command, the first snapshot object being visible to a user having access to the table;
cloning the table to generate a cloned version of the table;
storing the snapshot object in a first snapshot set in a first-tier storage, the first snapshot set comprising a first set of snapshot objects;
storing the cloned version of the table as a nested, hidden object underneath the snapshot object in the first-tier storage;
storing expression property (EP) files for the plurality of partition files with the snapshot object in the first snapshot set in the first-tier storage; and
storing an aggregate list of EP files of current snapshot objects in the first snapshot set in first-tier storage.

16. The system of claim 15, wherein at least one data file in the table and the cloned version of the table are shared in the first-tier storage.

17. The system of claim 15, wherein the first snapshot object and a second snapshot object in the first snapshot set share a first EP file corresponding to a partition shared by the first snapshot and second snapshot.

18. The system of claim 15, the operations further comprising:
determining that an archival time for the first snapshot object has expired; and
transferring the first snapshot object from active storage to a second-tier storage.

19. The system of claim 18, wherein retrieval times for the first-tier storage are shorter than retrieval times for the second-tier storage.

20. The system of claim 18, wherein transferring the first snapshot object comprises a second cloned version of the table nested underneath the first snapshot object in the second-tier storage, wherein the second cloned version is hidden from the user.

21. The system of claim 18, wherein EP files for the first snapshot object in the second-tier storage are stored in the active storage.
